(19) United States
(12) Patent Application Publication
(10) Pub. No.: US 2013/0030934 A1
(43) Pub. Date: Jan. 31, 2013

(54) SYSTEM AND METHOD FOR CREDIT CARD TRANSACTION APPROVAL BASED ON MOBILE SUBSCRIBER TERMINAL LOCATION

(71) Applicants: Chirag C. BAKSHI, San Jose, CA (US); Partha Roy Chowdhury, Los Altos, CA (US)

(72) Inventors: Chirag C. BAKSHI, San Jose, CA (US); Partha Roy Chowdhury, Los Altos, CA (US)

(73) Assignee: Zumigo, Inc., San Jose, CA (US)

(21) Appl. No.: 13/560,655

(22) Filed: Jul. 27, 2012

Related U.S. Application Data
(63) Continuation-in-part of application No. 13/016,368, filed on Jan. 28, 2011.

(51) Int. Cl. G06Q 20/40; G06Q 20/20

(52) U.S. Cl. 705/18; 705/44

(57) ABSTRACT

A user activity, which may be a credit card transaction or an on-line access, is approved based on the user's location at the time of the transaction or access. If the transaction or access is denied, the user may call or send a text message to the authorizing entity to permit the authorizing entity to determine the user's location. Then, the authorizing entity transmits a request to locate the user and receives location data indicating the location of the user in response thereto. If the user location is within a predetermined proximity to the location of the user activity, the user activity is authorized.

### CROSS-REFERENCE TO RELATED APPLICATION(S)

This application is a continuation-in-part of U.S. patent application Ser. No. 13/016,368, filed Jan. 28, 2011, the entire contents of which are incorporated by reference herein.

### BACKGROUND OF THE INVENTION

1. Field of the Invention

Embodiments of the present invention generally relate to credit card transaction security and, more specifically, to systems and methods for credit card transaction approval based on mobile subscriber terminal location.

2. Description of the Related Art

It has become common practice for individual consumers to use credit cards for conducting transactions not only at conventional point-of-sale (POS) locations, but also for on-line transactions performed on the Internet. In addition, credit cards are frequently used during foreign travel to avoid the fees associated with exchanging large amounts of cash into one or more foreign currencies. However, the convenience of credit card transactions is often negated by security measures commonly used to prevent fraudulent transactions, since transactions may be unexpectedly denied and additional action must be taken by the user to complete a transaction.

In on-line credit card transactions, particularly those exceeding a specified dollar amount, a bank or other authorization entity associated with the credit card may require identity verification by the user before authorizing a requested transaction. For example, a personal identification number (PIN) or other alpha-numeric credential may be sent via text message to a mobile subscriber terminal, e.g., a mobile phone, pre-registered as the mobile device of the credit card user. The user then uses the PIN to verify his or her identity to the authorization entity, which then authorizes the requested transaction. Identity verification using text messaging can be problematic since text messaging adds cost to each transaction, is not always reliably received by a targeted mobile device in a timely manner, and not all mobile phone users have text messaging plans.

In POS credit card transactions, a bank or other authorization entity associated with the credit card may deny any requested transactions that fall outside the normal pattern of use for that particular credit card, such as when the credit card is used for a transaction in a different country or city than the residence of the credit card user. When such transaction denials occur, the credit card user may be required to contact the authorization entity via a customer service phone number for transaction authorization, a procedure that can be time-consuming, frustrating, and, in cases where the user is engaged in foreign travel, quite expensive.

Accordingly, there is a need in the art for less cumbersome credit card transaction approval techniques, particularly for Internet-based transactions and transactions taking place during foreign travel.

### SUMMARY OF THE INVENTION

According to one or more embodiments, a user activity, which may be a credit card transaction or an on-line access, is approved based on the user's location at the time of the transaction or access. If the transaction or access is denied, the user may call or send a text message to the authorizing entity to permit the authorizing entity to determine the user's location. Then, the authorizing entity transmits a request to locate the user and receives location data indicating the location of the user in response thereto. If the user location is within a predetermined proximity to the location of the user activity, the user activity is authorized.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a conceptual diagram illustrating a system that enables location tracking of a mobile subscriber terminal, according to an embodiment of the present invention.

FIG. 2 schematically illustrates the contents of a location mapping database, according to an embodiment of the invention.

FIG. 3 is a conceptual diagram illustrating a system that enables location tracking of a mobile subscriber terminal roaming mode outside a home network, according to an embodiment of the present invention.

FIG. 4 schematically illustrates the contents of a mapping database, according to an embodiment of the invention.

FIG. 5A is a block diagram of a transaction processing system illustrating a point-of-sale financial transaction carried out according to an embodiment of the present invention.

FIG. 5B is a block diagram illustrating the steps of the point-of-sale financial transaction as they occur sequentially along a time line.

FIG. 6 is a block diagram illustrating the steps of the point-of-sale financial transaction as they occur sequentially along a time line.

For clarity, identical reference numbers have been used, where applicable, to designate identical elements that are common between figures. It is contemplated that features of one embodiment may be incorporated in other embodiments without further recitation.

### DETAILED DESCRIPTION

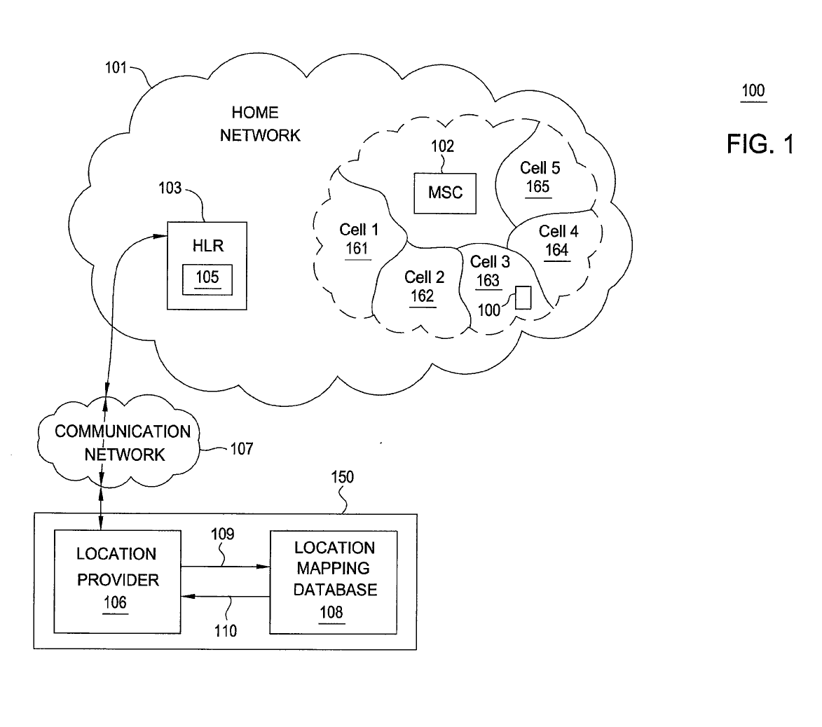

FIG. 1 is a conceptual diagram illustrating a system 150 that enables location tracking of a mobile subscriber terminal 100, according to an embodiment of the present invention. Mobile subscriber terminal 100 may be any type of wireless communication device, such as a cell phone, a smart phone, etc. As shown, mobile subscriber terminal 100, and presumably also the user of mobile subscriber terminal 100, is located in the primary serving network serving mobile subscriber terminal 100. The primary serving network of mobile subscriber terminal 100 is herein referred to as home network 101, and the user of mobile subscriber terminal 100 is referred to herein as a mobile subscriber.

Home network 101 is a wireless communication system that includes at least one Mobile Switching Center (MSC) 102, a Home Location Register (HLR) 103, and a plurality of cell towers 161-165. MSC 102 connects the landline public switched telephone network system to home network 101. Home network 101 may be a small network and only include a single MSC 102. Alternatively, home network 101 may be a relatively large network, i.e., a network that services a large geographical area, and may include multiple MSCs 102. For clarity, only a single MSC 102 is depicted in FIG. 1. Each MSC 102 in home network 101 has a plurality of cell towers 161-165 associated therewith, where each of cell towers 161-165 serves a specific geographical area, i.e., cells 1-5, respectively. HLR 103 of home network 101 contains geographical information regarding mobile subscriber terminal 100, where such geographical information may be a place name, a latitude-longitude coordinate or a combination of both. Specifically, HLR 103 contains a data structure 105 that identifies the particular MSC 102 currently serving mobile subscriber terminal 100 and the closest cell tower to mobile subscriber terminal 100. Information contained in data structure 105 includes a mobile subscriber identification number, MSC identification number (MSCID), cell tower number, mobile subscriber terminal serial number, an indicator telling the mobile subscriber terminal is in the home network, etc.

System 150 includes a location provider 106 and a location mapping database 108. Location provider 106 is a logical module, program, or algorithm that determines the location of mobile subscriber terminal 100 by querying location mapping database 108. Location mapping database 108 is a data structure that maps each MSC 102 in home network 101 to a specific geographical location. In some embodiments, location mapping database 108 also maps each of cell towers 161-165 to a specific geographical location. In some embodiments, system 150 may be an integral part of the Operational Support System (OSS) of the cellular service provider. Consequently, location provider 106 and location mapping database 108 may be constructed, maintained, and populated by the operator of home network 101. In other embodiments, system 150 may be a separate entity from home network 101 and therefore may be constructed, maintained, and populated by a third party.

Communication between home network 101 and system 150 is carried out via communication network 107. In some embodiments, communication network 107 may comprise the Internet, the Signaling System 7 (SS7) network, the Public Switched Telephone Network (PSTN) or a combination thereof. The SS7 network is used for communicating control, status, and signaling information between nodes in a telecommunication network.

In operation, when mobile subscriber terminal 100 physically enters the geographical region served by home network 101, mobile subscriber terminal 100 registers with home network 101 and MSC 102 captures the identity of the specific cell tower of cell towers 161-165 that is closest to mobile subscriber terminal 100. This registration process enables mobile subscriber terminal 100 to be alerted to an incoming phone-call or message. Calls are completed and messages delivered via this closest cell tower.

As mobile subscriber terminal 100 changes location in home network 101, the identity of the closest cell tower is maintained by MSC 102. Location provider 106 periodically queries HLR 103 via communication network 107 in order to track the current MSC and/or cell tower that is closest to mobile subscriber terminal 100. In some embodiments, the cell phone number associated with mobile subscriber terminal 100 is used to identify mobile subscriber terminal 100. In other embodiments, location provider 106 uses a serialized equipment number associated with mobile subscriber terminal 100 to identify mobile subscriber terminal 100. If the mobile registry is null, i.e., mobile subscriber terminal 100 is not currently registered in home network 101, then a “not-in-network” message is returned to location provider 106 by HLR 103.

After location provider 106 receives a reply from HLR 103 that identifies the closest MSC and/or cell tower to mobile subscriber terminal 100, location provider 106 queries location mapping database 108 via query 109. Query 109 includes the MSCID of said MSC and/or the appropriate cell tower number. Location mapping database 108 then returns the geographical location of MSC 102 to location provider 106 via reply 110. In some embodiments, the granularity of position of mobile subscription terminal 100 is enhanced by also providing cell tower location in reply 110. In other embodiments, inclusion of the geographical location of MSC 102 in reply 110 is sufficient. Thus, location provider 106 is continuously updated with the current geographical location of mobile subscriber terminal 100 and, presumably, the mobile subscriber, and consequently can provide such location information to any authorized party, e.g., employer, spouse, bank, on-line merchant, etc.

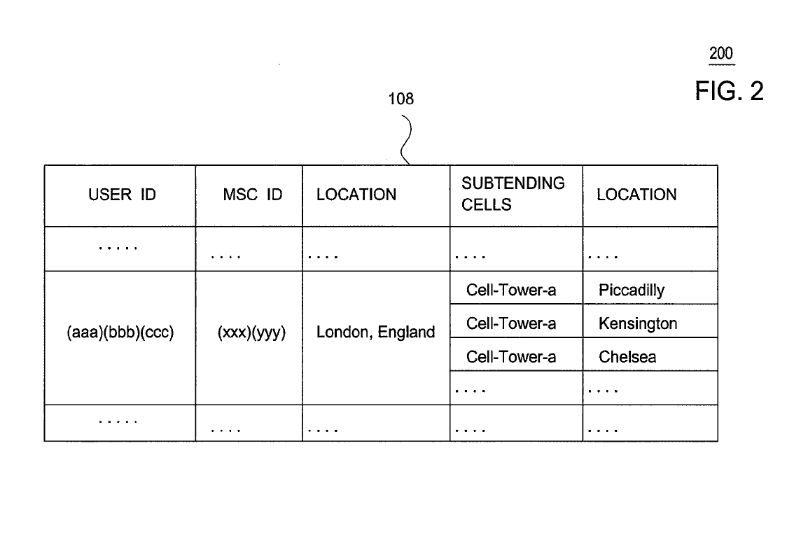

FIG. 2 schematically illustrates the contents of location mapping database 108, according to an embodiment of the invention. As shown, location mapping database 108 provides mappings of MSCs to the physical location of the area served by each MSC. In some embodiments, location mapping database 108 also includes the geographical locations corresponding to each subtending cell tower of each MSC included in mapping database 108.

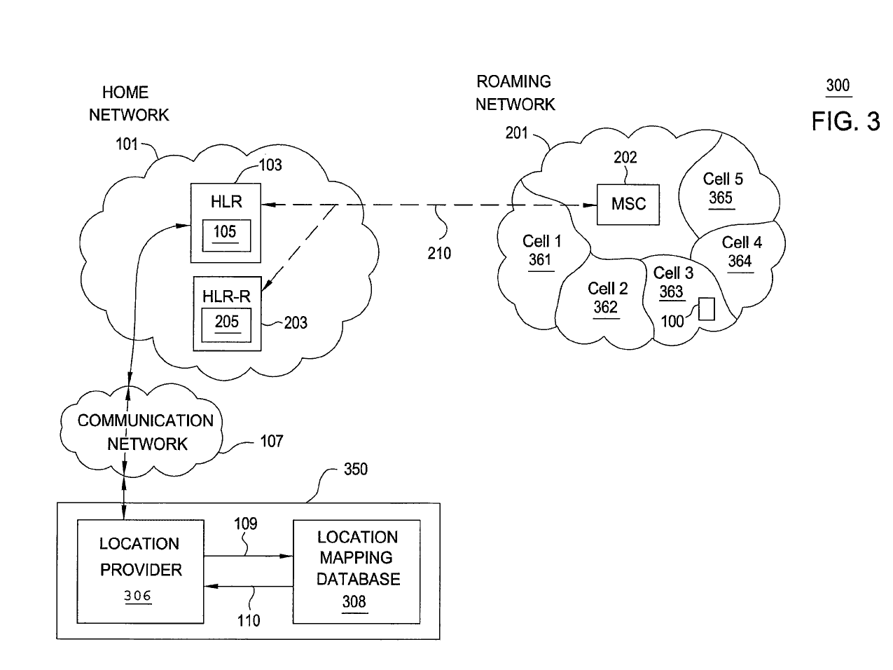

FIG. 3 is a conceptual diagram illustrating a system 350 that enables location tracking of a mobile subscriber terminal 100 roaming mode outside home network 101, according to an embodiment of the present invention. As shown, mobile subscriber terminal 100, and presumably also the mobile subscriber, is roaming outside home network 101 and is physically located in a roaming network 201, such as a cell phone network in a foreign country.

Roaming network 201 is substantially similar in organization and operation to home network 101, and includes one or more MSCs 202, each with its attendant cell towers 361-365. In addition to HLR 103, home network 101 includes a remote HLR, herein referred to as HLR-R 203. HLR-R 203 contains information regarding the MSC 202 in roaming network 201 in which mobile subscriber terminal 100 has registered. Similar to HLR 103, HLR-R 203 contains geographical information regarding mobile subscriber terminal 100. In contrast to HLR 103, HLR-R 203 contains a data structure 205 that identifies the particular MSC 202 in roaming network 201 that is currently serving mobile subscriber terminal 100. Information contained in data structure 205 includes a mobile subscriber identification number, MSC identification number, mobile subscriber terminal serial number, etc. In some embodiments, data structure 205 may also include the cell tower number of the closest cell tower to mobile subscriber terminal 100.

System 350 is substantially similar in organization and operation to system 150 in FIG. 1. One difference between system 350 and system 150 is that system 350 includes a location mapping database 308, analogous to mapping database 108, that maps each MSC 202 in one or more roaming networks, e.g., roaming network 201, to a specific geographical location. In some embodiments, location mapping database 308 also maps each of cell towers 361-365 to a specific geographical location. In some embodiments the database 308 also maintains a record of the last location mapped for the mobile subscriber terminal.

When mobile subscriber terminal 100 is outside home network 101, roaming network 201 accepts registry of mobile subscriber terminal 100, assuming there is a roaming agreement between the operator of home network 101 and the operator of roaming network 201. As part of normal operation of home network 101 and roaming network 201, the identity of mobile subscriber terminal 100 is communicated over a telephony signaling network 210 to home network 101, together with the appropriate MSC identification for MSC 202 for inclusion in data structure 205, where MSC 202 is the MSC currently serving mobile subscriber terminal 100. Such information that is communicated from roaming network 201 to home network 101 may be maintained in roaming network 201 in a database equivalent to data structure 105 in HLR 103 for mobile subscriber terminals from other networks, i.e., mobile subscriber terminals roaming in roaming network 201. This database containing information related to roaming subscriber units is called the Visitor Location Registry (VLR).

In operation, location provider 306 queries home network 101 regarding the location of mobile subscriber terminal 100. When HLR 103 is queried by location provider 306, mobile subscriber terminal 100 is discovered to be roaming. Location provider 306 then queries HLR-R 203, and receives the MSC ID of MSC 202, which is the MSC currently serving mobile subscriber terminal 100 in roaming network 201. The geographical location of mobile subscriber terminal 100 is then obtained from location mapping database 308 in the same way that system 150 obtains geographical location for mobile subscriber terminal 100 from location mapping database 108. Thus, location provider 306 is continuously updated with the current geographical location of mobile subscriber terminal 100, even when mobile subscriber terminal 100 is located in a foreign country or otherwise roaming outside home network 101. Consequently, location provider 306 can readily provide location information for mobile subscriber terminal 100 to any authorized party, e.g., employer, spouse, bank, on-line merchant, etc.

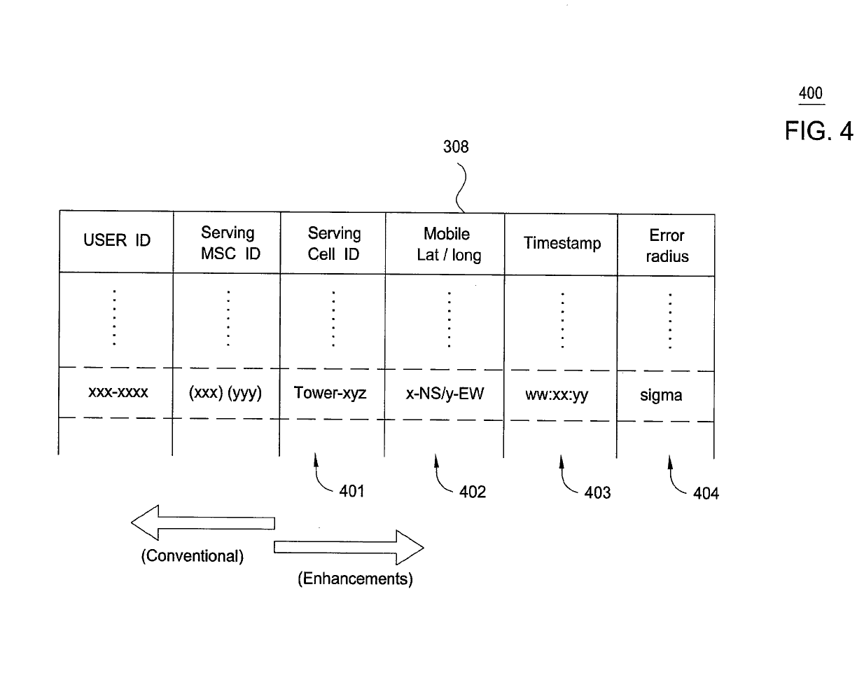

FIG. 4 schematically illustrates the contents of mapping database 308, according to an embodiment of the invention. Location mapping database 308 is substantially similar in organization to mapping database 108, except that, at a minimum, location mapping database 308 provides mappings of roaming MSCs to the physical location of the area served by all included roaming MSCs. Specifically, the roaming MSCs are selected from one or more roaming networks, e.g., roaming network 201, and not home network 101. Other elements of location mapping database 308 that are enhancements over prior art location mapping databases may include serving cell tower ID 401, latitude/longitude coordinate 402, timestamp 403, and error radius 404. The information contained in location mapping database 308 may be generated and maintained by home network 101 by surveying roaming network operators on an on-demand or on a scheduled basis.

In some embodiments, location mapping database 308 maps mobile subscriber terminal 100 to the physical location of a serving MSC in roaming network 201, e.g., MSC 202. Granularity of the position of mobile subscriber terminal 100 may be increased when location mapping data base 308 includes serving cell tower ID 401 and/or latitude/longitude coordinate 402 in roaming network 201, thereby mapping to the closest cell-tower and/or latitude/longitude coordinate. Latitude/longitude coordinate 402 may correspond to a fixed cell tower or MSC location, or may be a triangulated position between cell towers 361-365 that is determined by roaming network 201, or may be a GPS (Global Positioning Satellite) coordinate received directly from mobile subscriber terminal 100. Time-stamp 403 serves to indicate when the location entries were made to mapping database 308, and error radius 404 serves to quantify the granularity of the location estimate for mobile subscriber terminal 100.

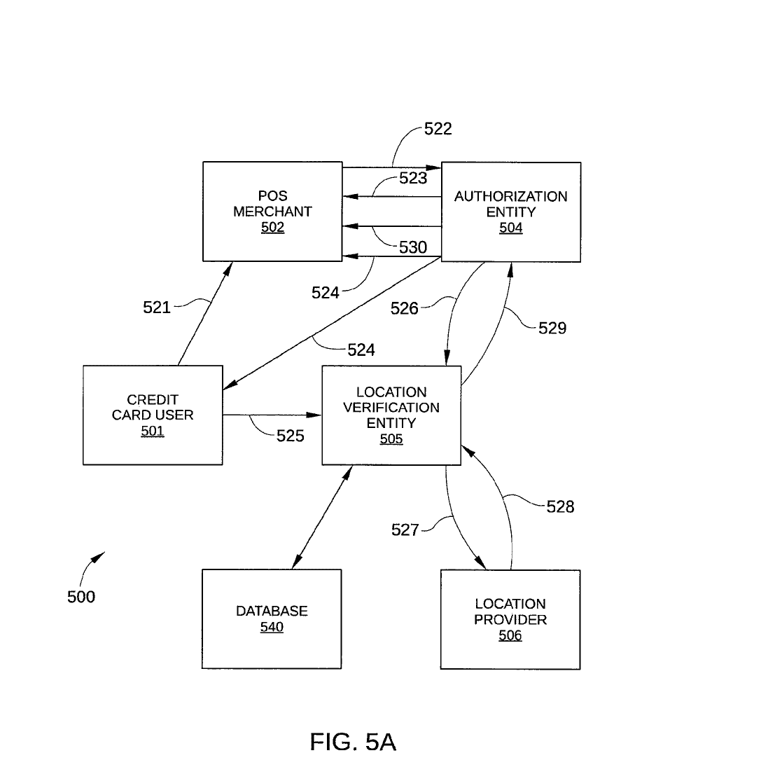

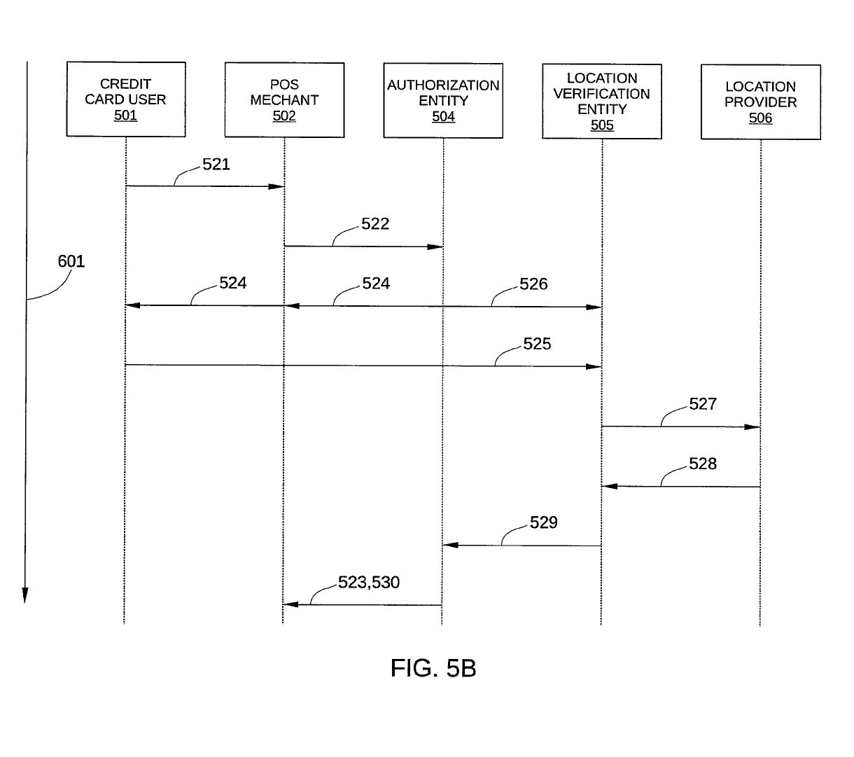

FIG. 5A is a block diagram of a transaction processing system 500 illustrating a point-of-sale (POS) financial transaction carried out according to an embodiment of the present invention, and FIG. 5B is a block diagram illustrating the steps of the POS financial transaction as they occur sequentially along a time line 601.

As shown, a credit card user 501 initiates a credit card transaction 521 at a POS merchant 502 by presenting a credit card. POS merchant 502 then submits an authorization request 522 to an authorization entity 504, such as the issuing entity of the credit card. POS merchant 502 accepts the credit card as form of payment for the purchase only when the transaction is authorized by authorization entity 504. Thus, POS merchant 502 only accepts the credit card for transaction 521 after receiving authorization response 523 from authorization entity 504. According to embodiments of the invention, authorization entity 504 does not authorize the transaction associated with authorization request 522 unless a two-factor authentication process involving verification of credit card user 501 location is successfully completed. Specifically, authorization response 523 is only issued by authorization entity 504 if the location of credit card user 501 is verified to be within a predetermined radius of the location of POS merchant 502. To that end, authorization request 522 includes location information for POS merchant 502 in addition to credit card transaction information that is normally sent to authorization entity 504.

In some embodiments, when authorization entity 504 receives authorization request 522, authorization entity 504 first determines whether a two-factor authentication process (involving verification of user location) is desired. For example, such two-factor authentication may be desired when authorization request 522 is recognized to fall outside the normal pattern of use for the credit card used for transaction 521, such as when POS merchant 502 is located outside a normal geographical region of use associated with the credit card (e.g., city, country, etc.). Similarly, two-factor authentication may be desired by authorization entity 504 when the transaction at POS merchant 502 exceeds a predetermined dollar amount, a predetermined frequency of use, and the like. In other embodiments, authorization entity 504 may require two-factor authentication as described herein for all transactions using a particular credit card.

When authorization entity 504 determines the need for two-factor authentication but credit card user 501 has not given prior authorization to locate the mobile subscriber terminal or mobile phone associated with_credit card user 501, authorization entity 504 denies authorization request 522 by transmitting a notification of transaction denial 524 to the credit card console located at POS merchant 502, to credit card user 501 directly, or to both POS merchant 502 and credit card user 501. In addition to notifying POS merchant 502 that authorization request 522 has been denied pending additional authentication, notification of transaction denial 524 also includes a message instructing credit card user 501 to call a telephone number associated with location verification entity 505 using the mobile phone or other mobile subscriber terminal that is associated with the credit card, e.g., mobile subscriber terminal 100 in FIG. 1. In this way, credit card user 501 can enable two-factor authentication of the transaction with POS merchant 502 by making call 525 to the provided telephone number. Upon receiving call 525 from credit card user 501, location verification entity 505 can then verify the location of credit card user 501 as described below.

In some embodiments, call 525 to the telephone number associated with location verification entity 505 is a conventional phone call. It is noted that with conventional caller identification technologies currently in use by authorization entities, such as credit card issuing agencies, a caller can be successfully identified without a call being completed. Thus, in some embodiments, credit card user 501 can call the telephone number associated with location verification entity 505 and can hang up once the called number begins to ring, thereby using a “missed call” to communicate the location of credit card user 501 to location verification entity 505. In such an embodiment, credit card user 501 does not have to incur the expense of a mobile phone call, which can be significant when roaming internationally. In other embodiments, call 525 may communicate with location verification entity 505 in a different manner, such as via a text message. In such embodiments, the text message may be a conventional short message service (SMS) message or may be a wireless chat message, such as Apple's iMessage, which avoids standard SMS texting fees. It is noted that any of the above embodiments is significantly less time-consuming and costly than making a call to a customer service phone number when a credit card transaction is denied while traveling. Furthermore, POS vendor 502 avoids the loss of business that often occurs when a credit card transaction is unexpectedly denied, since the call 525 takes place at the time and place of transaction 521, and can be completed in a few seconds.

In some embodiments, call 525 also acts as an authorization, or “opt-in,” action for allowing authorization entity 504 and/or location verification entity 505 to query location provider 506 for the current location of credit card user 501. Due to privacy issues associated with tracking the location of individuals without prior notification, the opt-in feature of call 525 establishes that credit card user 501 has explicitly authorized such a location look-up. In such embodiments, the opt-in configuration of call 525 may be introduced to credit card user 501 when a mobile phone or other mobile subscriber terminal is associated with a credit card as part of a registration process. Alternatively, an explanation of the opt-in action associated with call 525 may be included in notification of transaction denial 524.

In some embodiments, when authorization entity 504 determines the need for two-factor authentication, authorization entity 504 also transmits a notification of transaction denial 526 to location verification entity 505. Notification of transaction denial 526 informs location verification entity 505 that a location look-up is pending for the mobile subscriber terminal associated with credit card user 501 and the credit card being used for transaction 521. Notification of transaction denial 526 includes the credit card number used in transaction 521, location information associated with POS merchant 502, and the phone number of the mobile subscriber terminal associated with the credit card being used in transaction 521. In some embodiments, notification of transaction denial 526 may also include a desired error radius similar to error radius 404 in FIG. 4. In other embodiments, such an error radius is determined by location verification entity 505.

When location verification entity 505 receives call 525 from credit card user 501, location verification entity 505 confirms the location of credit card user 501 by querying a location provider 506 for the current location of the credit card holder. It is noted that in such embodiments, the mobile phone or other mobile subscriber terminal associated with the credit card has been pre-registered with authorization entity 504 prior to transaction 521, and call 525 is placed by the pre-registered mobile subscriber terminal. Location verification entity 505 sends location request 527 to location provider 506 and awaits location response 528. In some embodiments, location provider 506 is substantially similar in organization and operation to either location provider 106 in FIG. 1 or location provider 306 in FIG. 3, and determines the location of the mobile subscriber terminal associated with the credit card as described above in conjunction with FIGS. 1-4. After receiving location response 528, location verification entity 505 sends a user location verification 529 to authorization entity 504 indicating whether the mobile subscriber terminal associated with the credit card and credit card user 501 is proximate the location of POS merchant 502. In some embodiments, location provider 506 is not queried each and every time that credit card user 501 initiates credit card transaction 521, since the location of credit card user is saved locally in a database associated with authorization entity 504. In such embodiments, the number of location look-ups requested by authorization entity 504 is advantageously reduced.

Upon receiving location response 528, location verification entity 505 determines the proximity of the mobile subscriber terminal associated with the credit card to the location of POS merchant 502. Presumably, credit card user 501 has the same location as the mobile subscriber terminal associated with the credit card and with credit card user 501. If the current location of credit card user 501, as determined by location verification entity 505, is not within a predetermined radius of the physical location of POS merchant 502, location verification entity 505 transmits a location verification 529 to authorization entity 504 indicating that credit card user 501 is not present at POS merchant 502 for transaction 521. Thus, an unauthorized user may be fraudulently using the credit card for transaction 521. Consequently, authorization entity 504 denies authorization request 522 by transmitting authorization denial 530 to POS merchant 502. If the current location of credit card user 501 is within a predetermined radius of the physical location of POS merchant 502, location verification 530 indicates that credit card user 501 is present at POS merchant 502 for transaction 521. Thus, an unauthorized user is not fraudulently using the credit card for transaction 521. Authorization entity 504 may then further base the authorization of authorization request 522 on other parameters such as credit limit, etc.

In some embodiments, interactions with credit card user 501 are minimized by configuring location verification entity 505 with a database 540 of registered credit card users that have “opted-in” for pre-authorized location look-up by authorization entity 504 and/or location verification entity 505. Database 540 is configured to store the numbers of credit cards issued by authorization entity 504, the number of any mobile subscriber terminal associated with each credit card, and the current location look-up authorization status. Current location look-up authorization status indicates if the credit card user associated with a specific credit card has authorized location verification by authorization entity 504 and/or location verification entity 505. In such embodiments, a credit card user may opt-in to authorize authorization entity 504 and/or location verification entity 505 to perform location verification at some time prior to transaction 521. For example, the credit card user may opt-in when a mobile subscriber terminal is initially registered with authorization entity 504 to be associated with the credit card. In another example, the credit card user may opt-in prior to traveling outside the normal use area of the credit card. Furthermore, the credit card user may opt-in by making call 525. In such an embodiment, when call 525 is received, location verification entity 505 may update the opt-in status of the credit card in database 540 so that future transactions at POS merchants can utilize a two-factor authentication process based on user location without the need for credit card user 501 to make call 525 as described above. Instead, when database 540 indicates that credit card user 501 has already opted-in to location verification, notification of transaction denial 524 is not transmitted to POS merchant 502 or credit card user 501, and call 525 is not needed by location verification entity 505 to verify the location of credit card user 501; location verification entity 505 queries location provider 506 directly without receiving call 525.

In the embodiment illustrated in FIGS. 5A and 5B, multiple entities included in transaction processing system 500 each perform the different actions of transaction processing system 500. Specifically, authorization entity 504 determines the need for two-factor authentication and whether transaction 521 is denied or authorized, location verification entity 505 determines if credit card user 501 is located proximate POS merchant 502, and location provider 506 determines the current location of credit card user 501. In such an embodiment, some or all of the communications described may be transmitted via one or more wireless and/or wired communication networks, such as communication network 107 in FIG. 1. Such communications include authorization request 522, authorization response 523, notification of transaction denial 524, call 525, notification of transaction denial 526, location request 527, location response 528, location verification 529, and authorization denial 530. In other embodiments, authorization entity 504, location verification entity 505, and location provider 506 may be configured as a single operational module, and some or all of the communications described herein may not be transmitted via an external communications network.

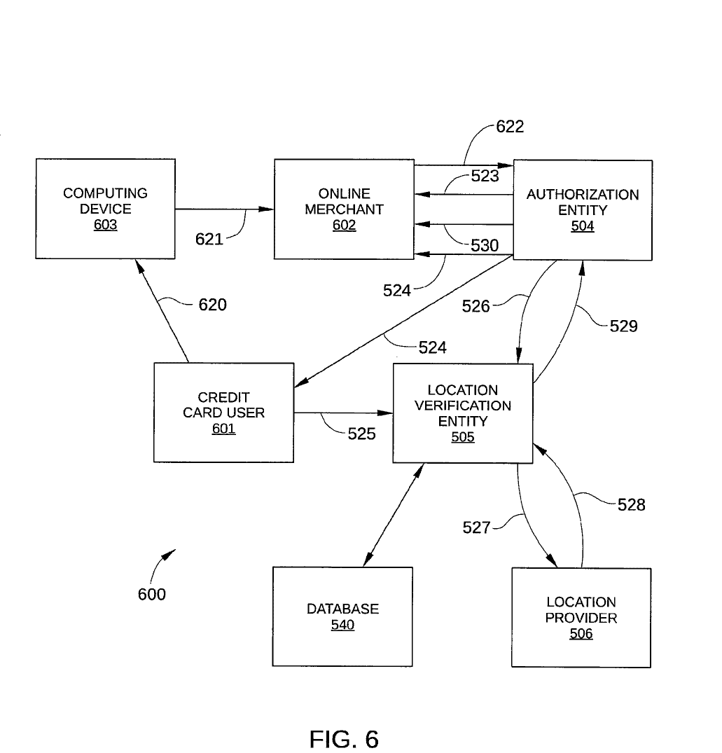

In the embodiment illustrated in FIGS. 5A and 5B, a transaction using a credit card at a POS merchant is depicted. In other embodiments, a credit card is used for other types of transactions, such as transactions performed on-line via the Internet. In the case of on-line transactions, authorization of a credit card transaction can be contingent on the location of the computer being used to initiate the on-line transaction. The location of said computer is extracted from the computer IP address and compared to the current location of the mobile subscriber terminal associated with the credit card. FIG. 6 depicts one such embodiment.

FIG. 6 is a block diagram of a transaction processing system 600 illustrating an on-line financial transaction carried out according to an embodiment of the present invention. As shown, credit card user 601 provides a credit card number 620 to initiate a credit card transaction 621 using a computing device 603 connected to the Internet, such as a desktop or laptop computer, an electronic tablet, a smart phone, and the like. Via the Internet or other communication network, computing device 603 facilitates credit card transaction 621 with on-line merchant 602. Credit card transaction 621 includes credit card number 620 and the I.P. address of computing device 603. Upon receipt of transaction 621, on-line merchant 602 submits an authorization request 622 to authorization entity 504, and accepts credit card number 620 as form of payment for the purchase only when the transaction is authorized by authorization entity 504. Thus, on-line merchant 602 only accepts the credit card for transaction 621 after receiving authorization response 523 from authorization entity 504. According to embodiments of the invention, authorization entity 504 does not authorize the transaction associated with authorization request 622 unless a two-factor authentication process involving verification of user location is successfully completed. Specifically, authorization response 523 is only issued by authorization entity 504 if the location of credit card user 601 is verified to be within a predetermined radius of the physical location associated with the I.P. address of computing device 603. To that end, authorization request 622 includes the I.P. address of and/or location information for computing device 603, in addition to transaction information that is normally sent to authorization entity 504. In other respects, transaction processing system 600 is substantially similar in organization and operation to transaction processing system 500 in FIGS. 5A and 5B.

In sum, one or more embodiments of the invention provide techniques for providing a two-factor authentication process for a credit card transaction, where the second authentication factor includes verification of user location at the time of the transaction. Advantageously, verifying the location of a credit card user based on the location of a mobile subscriber terminal associated with the credit card makes two-factor authentication of credit card transactions more convenient and reliable, and less costly, than techniques known in the art.

While the foregoing is directed to embodiments of the present invention, other and further embodiments of the invention may be devised without departing from the basic scope thereof, and the scope thereof is determined by the claims that follow.

We claim:

1. A method of authorizing a transaction, said method comprising the steps of:
receiving a request to authorize a transaction being conducted at a point-of-sale (POS);
acquiring purchaser data from the request;
receiving an approval to permit an authorizing entity to determine a location of the purchaser;
transmitting a request to locate the purchaser and receiving location data indicating the location of the purchaser in response thereto;
comparing a POS location with the purchaser location; and
authorizing or denying the transaction based on the step of comparing.

2. The method of claim 1, wherein the approval is determined from a telephone call received from a mobile subscriber terminal associated with the purchaser.

3. The method of claim 2, wherein the telephone call is received after the transaction is denied.

4. The method of claim 1, wherein the approval is determined from a text message received from a mobile subscriber terminal associated with the purchaser.

5. The method of claim 4, wherein the text message is received after the transaction is denied.

6. The method of claim 1, wherein the approval is a pre-approval given by the purchaser prior to the transaction.

7. The method of claim 1, further comprising:
after said transmitting and receiving the location data, storing the purchaser location;
receiving a request to authorize a transaction being conducted at another point-of-sale (POS); and
authorizing or denying the transaction being conducted at said another POS based on a comparison of a location of said another POS with the stored purchaser location.

8. The method of claim 7, wherein the stored purchaser location is determined to be valid for said authorizing or denying the transaction being conducted at said another POS based on a lapsed time between the transactions.

9. The method of claim 7, wherein the stored purchaser location is determined to be valid for said authorizing or denying the transaction being conducted at said another POS based on a time stamp of the stored purchaser location and a time of the transaction being conducted at said another POS.

10. A method of authenticating a user for access to a secure account, comprising the steps of:
receiving a request to access the secure account from an IP address associated with the user;
receiving an approval to permit an authorizing entity to determine a location of the purchaser;
transmitting a request to locate the user and receiving location data indicating the location of the user in response thereto;
comparing a location associated with the IP address with the location of the user; and
authorizing or denying the access based on the step of comparing.

11. The method of claim 10, wherein the approval is determined from a telephone call received from a mobile subscriber terminal associated with the purchaser.

12. The method of claim 11, wherein the telephone call is received after the access request is denied.

13. The method of claim 10, wherein the approval is determined from a text message received from a mobile subscriber terminal associated with the purchaser.

14. The method of claim 13, wherein the text message is received after the access request is denied.

15. The method of claim 10, wherein the approval is a pre-approval given by the purchaser prior to the transaction.

16. The method of claim 10, further comprising:
after said transmitting and receiving the location data, storing the user location;
receiving a request to access the secure account from another IP address associated with the user; and
authorizing or denying the access to the secure account from said another IP address based on a comparison of a location of said another IP address with the stored user location.

17. The method of claim 16, wherein the stored user location is determined to be valid for said authorizing or denying the access to the secure account from said another IP address based on a lapsed time between the accesses.

18. The method of claim 16, wherein the stored user location is determined to be valid for said authorizing or denying the access to the secure account from said another IP address based on a time stamp of the stored user location and a time of the secure account from said another IP address.

19. A non-transitory computer readable storage medium comprising instructions to be executed in a computing device to carry out a method of authorizing a user activity, said method comprising the steps of:
receiving a request to authorize the user activity;
receiving an approval to permit an authorizing entity to determine a location of the user;
transmitting a request to locate the user and receiving location data indicating the location of the user in response thereto;
comparing a location of the user activity with the user location; and
authorizing the user activity if the user location is within a predetermined proximity to the location of the user activity.

20. The non-transitory computer readable storage medium of claim 19, wherein the approval is determined from a telephone call or a text message that is received after the request to authorize the user activity has been denied.
